(19) United States
(12) Patent Application Publication
(10) Pub. No.: US 2011/0120503 A1
(43) Pub. Date: May 26, 2011

(54) RINSING/SANITIZING SYSTEM FOR A WASHING MACHINE

(76) Inventors: JOHN CANTRELL, LEAWOOD, KS (US); MARK CHURCHILL, GRAIN VALLEY, MO (US)

(21) Appl. No.: 12/781,750

(22) Filed: May 17, 2010

Related U.S. Application Data
(60) Provisional application No. 61/178,617, filed on May 15, 2009.

(51) Int. Cl. B08B 3/00

(52) U.S. Cl. 134/26; 134/84

(57) ABSTRACT

A rinsing and/or sanitizing system for a washing machine, such as a pot and pan washing machine, is provided. In one embodiment, the system includes two sections of conduit with fluid-dispensing openings or nozzles and a third section of conduit connecting the other two sections. The nozzles spray fluid into the space between the conduits, creating a curtain of fluid, in a common plane. In a preferred embodiment, the fluid sprayed is water to rinse items. In another preferred embodiment, the fluid sprayed is a sanitizing agent to sanitize items. In still another embodiment, the system sprays both water and a sanitizing agent. Another aspect of the invention is a method of rinsing and/or sanitizing an item by moving the item through the curtain of fluid of the rinse system.

### CROSS-REFERENCE TO RELATED APPLICATIONS

This application claims priority pursuant to 35 U.S.C. 119(e) to co-pending U.S. Provisional Patent Application Ser. No. 61/178,617, filed May 15, 2009, the entire disclosure of which is incorporated herein by reference.

### FIELD OF THE INVENTION

The present invention relates generally to an apparatus and method for cleaning wares and other items. More specifically, the present invention is concerned with a rinse system “window”™ for a washing machine that creates a curtain of fluid through which wares or other items are passed for cleansing/rinsing and/or sanitizing.

### BACKGROUND OF THE INVENTION

Pot and pan washing machines, of the type used in restaurants, institutions and other facilities often involve a large wash tank or basin in which fluid is circulated about the pots and pans to provide a washing action. One such machine is described in U.S. Pat. No. 4,773,436 issued to Cantrell et al., the entire disclosure of which is incorporated herein by reference. The inventions disclosed in U.S. Pat. Nos. 6,739,348; 6,976,496; 7,162,788; and 7,246,624, and U.S. patent application Ser. Nos. 11/074,269; 11/775,465; 12/020,223, and 12/430,724, the entire disclosures of which are incorporated herein by reference, provide a number of improvements to machines such as disclosed in U.S. Pat. No. 4,773,436. Nevertheless, the efficiency and effectiveness of the machines and methods of washing objects can be improved. In particular, the machine disclosed in the patents and applications referenced above all typically include a separate scrap basin, wash tank, rinse tank, and sanitizer tank, as well as counter-top work surfaces. This results in a considerably large footprint for the overall machine. As space within kitchens is typically a premium, it is desirable to minimize the footprint as much as possible, In addition, it is desirable to provide a system and method of cleaning objects, that adequately cleans and/or rinses and/or sanitizes all surfaces of the objects while quickly and easily moving the objects from one point to another.

### SUMMARY OF THE INVENTION

An object of the present invention is to minimize the footprint of washing machines, such as pot and pan washing machines. Another object of the present invention is to provide a system and method of cleaning objects, that adequately cleans and/or rinses and/or sanitizes all surfaces of the objects while quickly and easily moving the objects from one point to another. Still another object of the present invention is to provide a system and method of cleaning objects, that adequately cleans and/or rinses and/or sanitizes all surfaces of the objects while minimizing the footprint of the cleaning apparatus.

According to the above described objects of the instant invention, a washing machine, such as a pot and pan washing machine, is provided that includes a rinsing and/or sanitizing system “window”™ that creates a curtain of water (or other fluid, including rinse agents and/or sanitizing agents) generally within a single plane (or multiple curtains of fluid within two or more generally parallel planes) within the footprint of the washing machine. In one embodiment, the rinse/sanitize “window”™ includes two sections of conduit with fluid-dispensing nozzles or openings located generally parallel to one another, and a third section of conduit positioned generally perpendicular to and connecting the other two sections together to form a “U” or “C” shaped “window”™. The “window”™ includes an opening toward a front end and all three sections of conduit lie in a common generally vertical plane. It will be appreciated that a single section of conduit forming a generally “U” or “C” shape may be utilized without departing from the spirit and scope of the instant invention. In addition, separate unattached sections of conduit that lie in a single plane may be utilized without departing from the spirit and scope of the instant invention. Moreover, it will be appreciated that alternative shapes of the “window”™ of the instant invention may be utilized to create the generally planar curtain(s) of fluid; including, but not limited to a fully enclosed (i.e. four sides or sections of conduit) “window”™.

The nozzles/openings of a preferred embodiment are sized, shaped and located such that they spray fluid generally toward each other, into the space between the sections of conduit, creating a curtain (or curtains) of fluid generally within the common plane (or generally parallel planes) in which sections of conduit are located. In some embodiments in which three conduit sections are utilized as is discussed above, nozzles/openings are located on two sections of conduit that are parallel to one another. In alternative embodiments, nozzles/openings may be located on all sections (e.g. all three sections of a u-shaped or c-shaped three section conduit) conduit, on any single section of conduit, or any combination of sections of conduit.

The rinse/sanitize “window”™ of the present invention may be used in combination with any washing machine, including but not limited to those pot and pan and other washing machines described above with respect to the prior art, to reduce the overall footprint of the machine and/or to decrease the time and effort in washing and/or rinsing and/or sanitizing objects. In one preferred embodiment, a rinsing (and/or sanitizing) “window”™ of the present invention is mounted over an end portion of a wash tank/sink of a washing machine, such that fluid from the rinsing/santizing “window”™ drains into the wash tank. Such an arrangement allows the rinse and/or sanitizer tank to be eliminated, for the size of the rinse and/or sanitizer tanks to be reduced, for a single tank to function as a backup rinse/sanitizing tank in place of separate rinse and sanitizer tanks, for rinse/sanitizer tanks to be replaced with work surfaces, drain boards or other object, or for other reallocation or replacement of rinse/sanitizer tank space (e.g. lids over tanks to function as work surfaces). In this manner, the washing, rinsing and sanitizing processes that are traditionally accomplished in a three sink apparatus may be accomplished in an apparatus with as little as one sink (i.e. a wash sink).

In some embodiments multiple “windows”™ are utilized in which one “window”™ is used for rinsing items and another “window”™ is used for sanitizing items. In other embodiments, one “window”™ dispenses both rinsing agents and sanitizing agents, either as two individual actions, or together in a single mixture or combined rinsing/sanitizing agent. In still another embodiment, a sanitizing apparatus is located or attached generally adjacent to a rinse “window”™ to sanitize items after they are rinsed in the rinse “window”™. In some embodiments, the sanitizing apparatus utilizes a non-fluid sanitizing agent, such as UV light, radio waves, etc.

The conduit sections of the rinse/sanitize “window”™ are operably connected to a source of fluid. In some embodiments, the fluid is ordinary tap water. In some embodiments, the fluid is a sanitizing fluid pumped from an operably connected tank. In some embodiments, the fluid is a combination of cleansing agents.

In some embodiments, the rinse “window”™ also includes a control for initiating and/or stopping the flow of fluid through the nozzles/openings. In some embodiments, the fluid flow is controlled by a manually operated foot pedal. In some embodiments, the fluid flow is controlled by an optical sensor that detects when an object is passed through the common plane in which the three sections of conduit are located. In other embodiments, the fluid flow is controlled by a pressure sensitive “start” or activation/deactivation button.

The conduit sections and/or nozzles/openings may be arranged such that the generally planar curtain (or curtains) of fluid is formed vertically, horizontally, or at any variety of angles. In some embodiments, the rinse/santize “window”™ includes a splash shield. In some embodiments, the rinse/sanitize “window”™ includes a platform extending through the curtain(s) of fluid and disposed substantially perpendicular thereto, without significantly blocking fluid flow from the nozzles/openings.

Another aspect of the invention is a method of cleaning/sanitizing an object by moving the object through the curtain of fluid of the rinse/sanitize “window”™ described above.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings.

FIG. 1 is a front perspective view of a rinsing/sanitizing system “window”™ of an embodiment of the instant invention.

FIG. 2 is a top view of the rinsing/sanitizing system “window”™ of FIG. 1, shown in connection with a portion pot and pan washing machine.

FIG. 3 is a front view of the portion of the pot and pan washing machine of FIG. 2.

FIG. 4 is a front view of the pot and pan washing machine of FIGS. 2 and 3, that includes the rinsing/sanitizing “window”™ of FIG. 1.

FIGS. 5 and 6 are perspective views of the pot and pan washing machine of FIG. 4.

FIGS. 7-9 are perspective views another pot and pan washing machine that includes a flat-surface work-area in place of rinse and sanitizer tanks and that includes the rinsing/sanitizing “window”™ of FIG. 1.

FIG. 10 is a perspective view of the rinsing/sanitizing “window”™, shown in connection with a portion of the pot and pan washing machine of FIGS. 7-9.

FIGS. 11-14 show front views of several pot and pan washing machine embodiments that utilize rinsing/sanitizing systems of FIG. 1.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for any claims and as a representative basis for teaching one skilled in the art to variously employ the present invention in virtually any appropriately detailed structure.

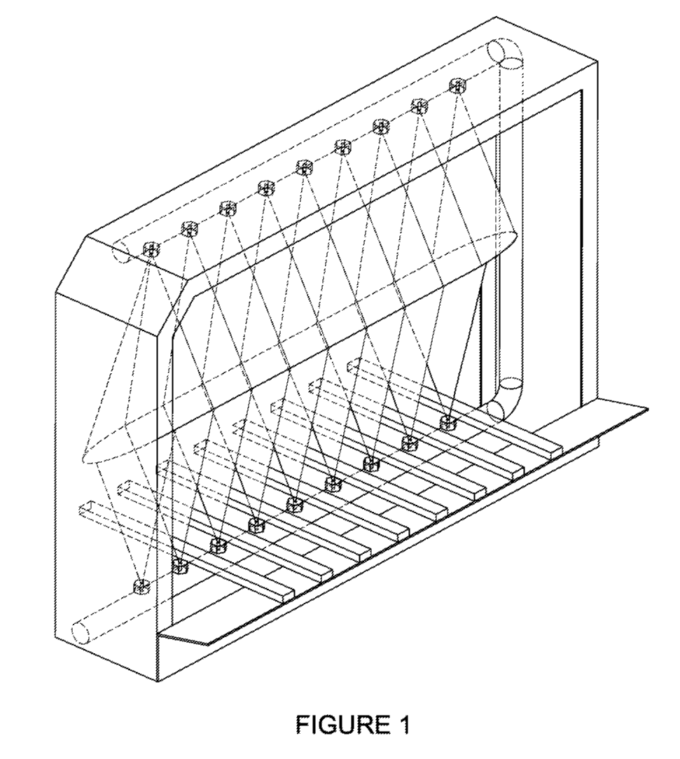

Referring to FIG. 1, a perspective view of the rinse “window”™ 10 is shown. Two sections of conduit, 12 and 14, are arranged parallel to each other and in a common plane. Each of the two parallel conduits includes nozzles 18 to dispense fluid. The nozzles are arranged along the conduits such that they direct fluid flowing through them toward the opposite conduit. A third section of conduit 16 connects the two parallel conduits and all three lie in a common plane. As fluid is directed out the nozzles of the two parallel conduits, each toward the other, a curtain of fluid is created between the conduits and along the common plane.

The conduits are operably connected to a source of fluid. In some embodiments, the fluid is ordinary tap water and the conduits are operably connected directly to the plumbing system via a hose, pipe or other conduit to the plumbing system (not shown). In some embodiments, the fluid is a sanitizing fluid pumped from a tank that is operably connected to the conduits via a hose, pipe or other conduit (not shown). In some embodiments, the fluid is a combination of cleansing agents or other fluids. For example, the conduits may be configured to spray a mixture of water and sanitizer, or may alternately spray water and sanitizer. In some embodiments in which the conduits alternately spray two or more different fluids, a separate hose, pipe or conduit operably connects the rinsing/sanitizing “window”™ 10 (or multiple “windows”™) to each fluid source.

In some embodiments, the rinse/sanitizer “window”™ also includes a control for initiating and/or stopping or otherwise controlling (e.g. reducing or increasing) the flow of fluid through the nozzles. The flow of fluid may be controlled manually or automatically. By way of example and not by way of limitation, the flow of fluid may be controlled via a foot pedal, optical sensor, or push button.

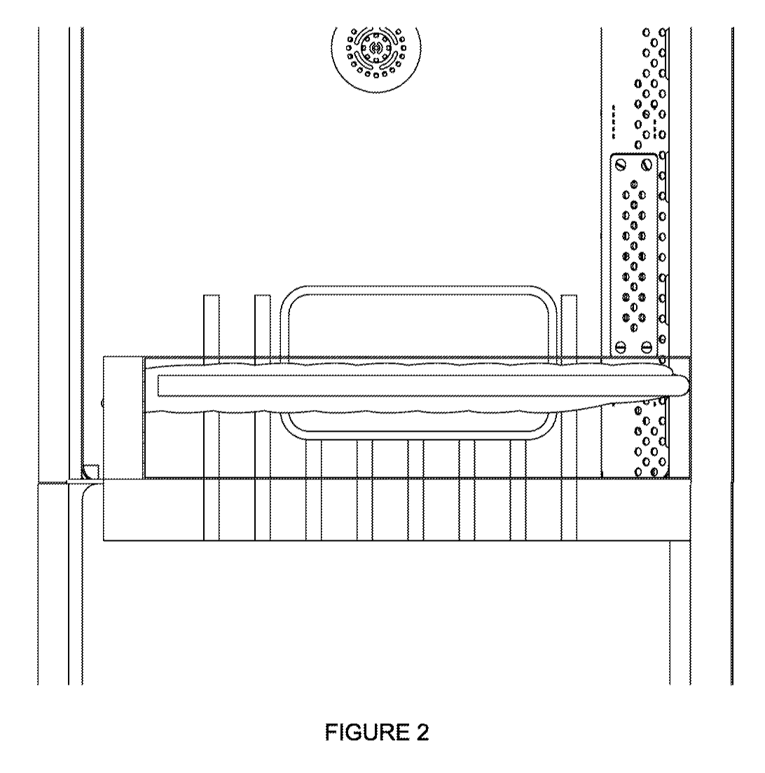

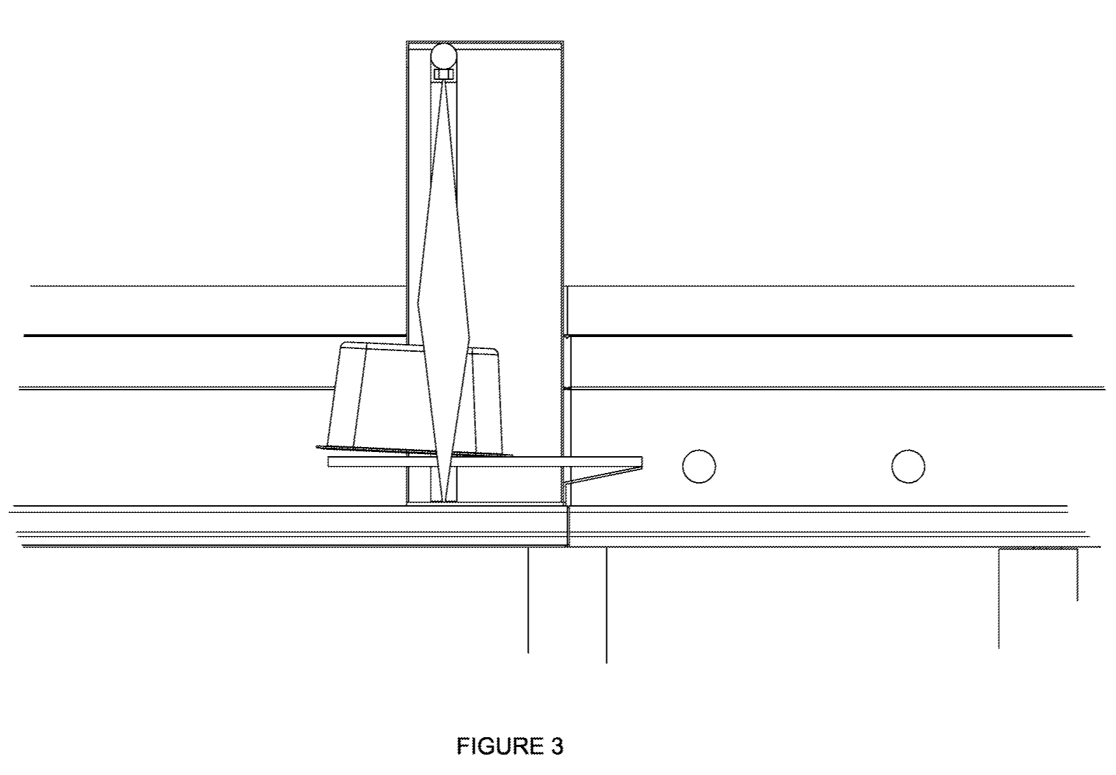

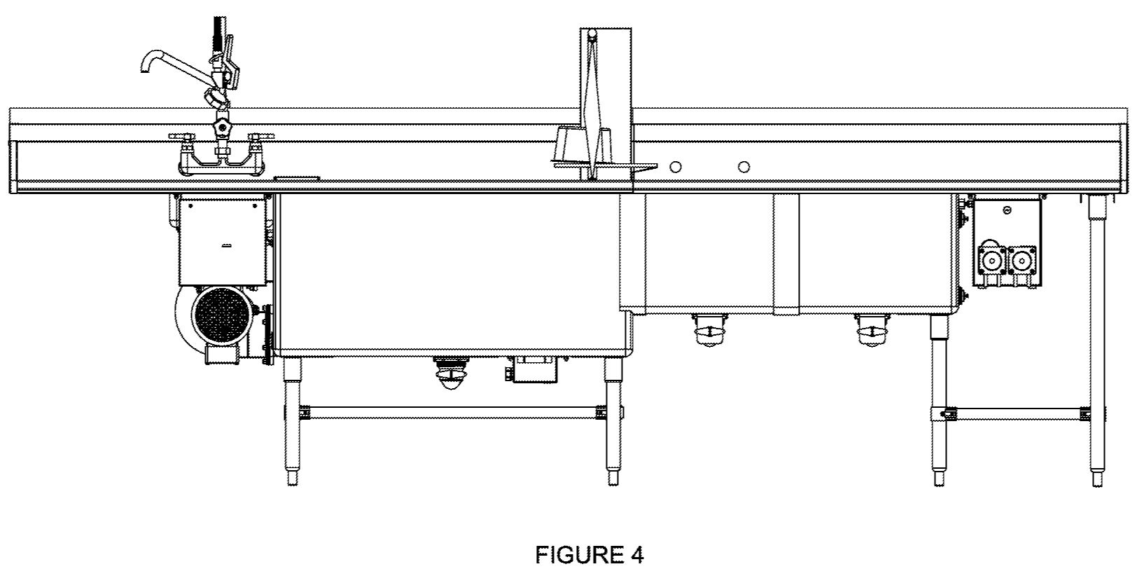

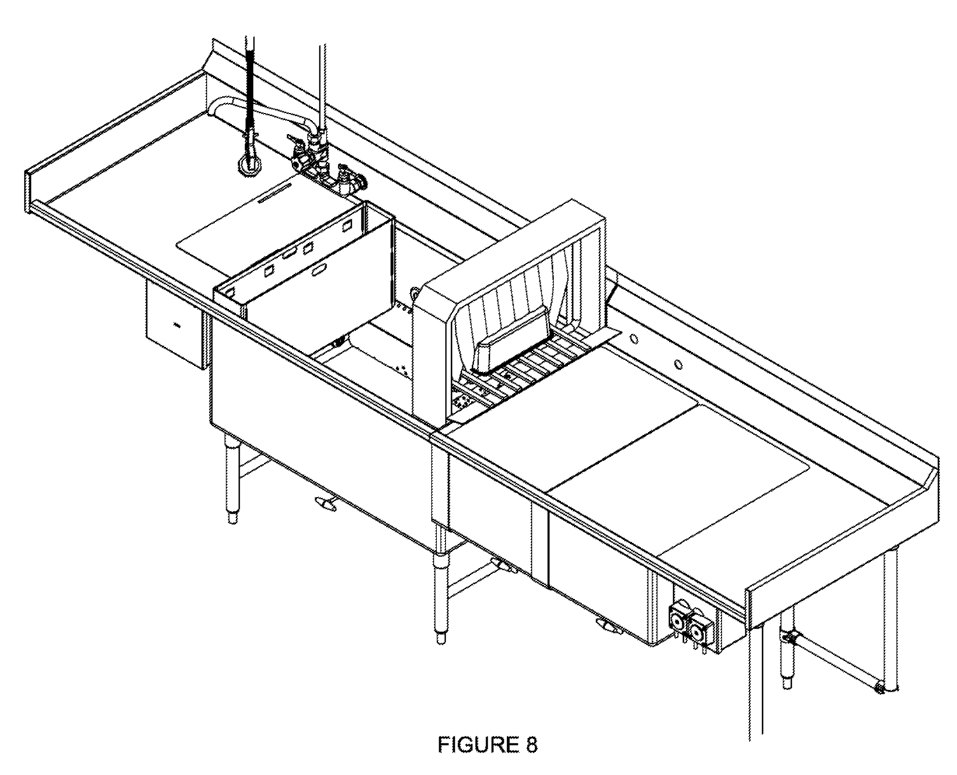

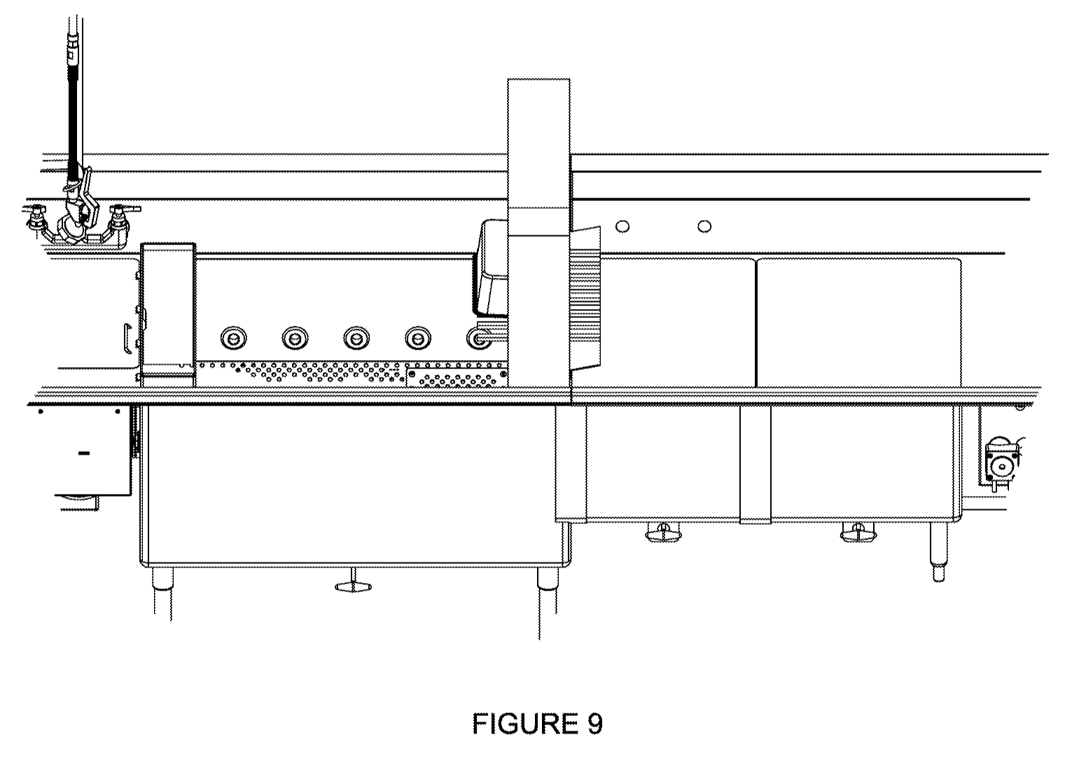

The conduits may be arranged such that the curtain of fluid is formed vertically, horizontally, or at any angle desired. In a preferred embodiment, as shown in FIGS. 2 through 14, the conduits are arranged such that the curtain of fluid is formed vertically to minimize the footprint of the system. In the systems shown in FIGS. 2-14, the conduit 14 on the bottom includes nozzles 18 arranged to discharge fluid through them toward the conduit 12 on top. Similarly, the conduit on top includes nozzles 18 arranged to discharge fluid through them toward the conduit on bottom. As shown in FIGS. 2-4, the conduits lie in a common plane and the fluid discharged through the nozzles is dispelled into the common plane toward the opposing conduit.

The rinse/sanitizer “window”™ shown in the figures also includes a splash shield 20. Fluid discharged through the nozzles is generally contained within the confines of the splash shield. In the examples shown in the figures, the splash shield circumscribes at least three sides of the common plane of the rinse/sanitizer “window”™, including the front, back and top sides of the rinse “window”™. In other embodiments, the splash shield is open at the front side to allow an operator to easily move an item through the rinse/sanitizer “window”™ while standing at the front of the machine. The splash shield is made of metal, plastic, or any other suitable material, and is wider than the diameter of the conduit to prevent fluid from splashing out of the area generally surrounding the rinse/sanitizer “window”™. The splash shield is preferably at least as wide as the width of the discharge spray from the nozzles.

The rinse/sanitizer “window”™ shown in the figures also includes a platform extending through the curtain of fluid. The platform is disposed substantially perpendicular to the common plane of the rinse “window”™. The platform extends through the curtain of fluid, without blocking fluid flow from the nozzles. As shown in FIGS. 1 and 2, the platform includes several elongated segments/tracks 30, with each elongated segment disposed between two nozzles of the lower conduit. The elongated segments are connected on one end to a support member 35 that is attached or attachable to a portion of a pot and pan washing machine. In this manner, the elongated segments extend or are cantilevered over the lower-most conduit section of the rinse “window”™. In one embodiment, the segments include a generally low friction outer surface to allow pots, pans and other wares to easily slide across the platform. In other embodiments, the segments include a motorized conveyor system to aid in moving wares across the platform. Other arrangements and configurations of the platform will be readily apparent to those of ordinary skill in the art.

Referring to FIGS. 2-6 an embodiment of a pot and pan washing machine 100 that includes the rinse/sanitizer “window”™ 10 of FIG. 1 is shown. The pot and pan washing machine shown in FIGS. 2-6 includes, from left to right, a scrap tank 110, a wash tank 120, a rinse tank 130 and a sanitizer tank 140. The rinse/sanitizer “window”™ is mounted between the wash tank 120 and the rinse tank 130. The support member 35 of the platform of the rinse/sanitizer “window”™ is attached to the side of the rinse tank such that the elongated segments 30 of the platform extend over a portion of the wash tank 120. As is shown in FIG. 2, the support member 35 includes a solid portion 37 that is located over the top of the rinse tank 130. This solid portion is angled downward toward the wash tank 120 and acts to prevent fluid from the rinse/sanitizer “window”™ from running into the rinse tank. The open arrangement of the elongated segments, however, allows fluid to drain from the rinse/sanitizer “window”™ into the wash tank. In a preferred embodiment, the elongated segments 30 are angled downward toward the rinse tank 130 to allow items to be more easily moved in a direction away from the wash tank 120.

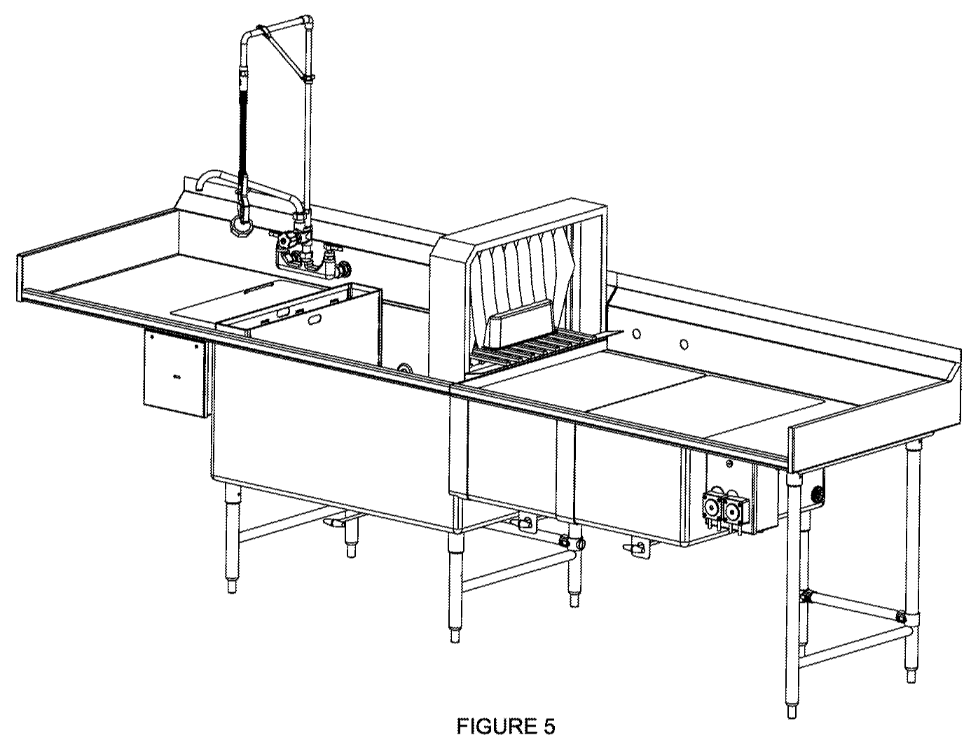

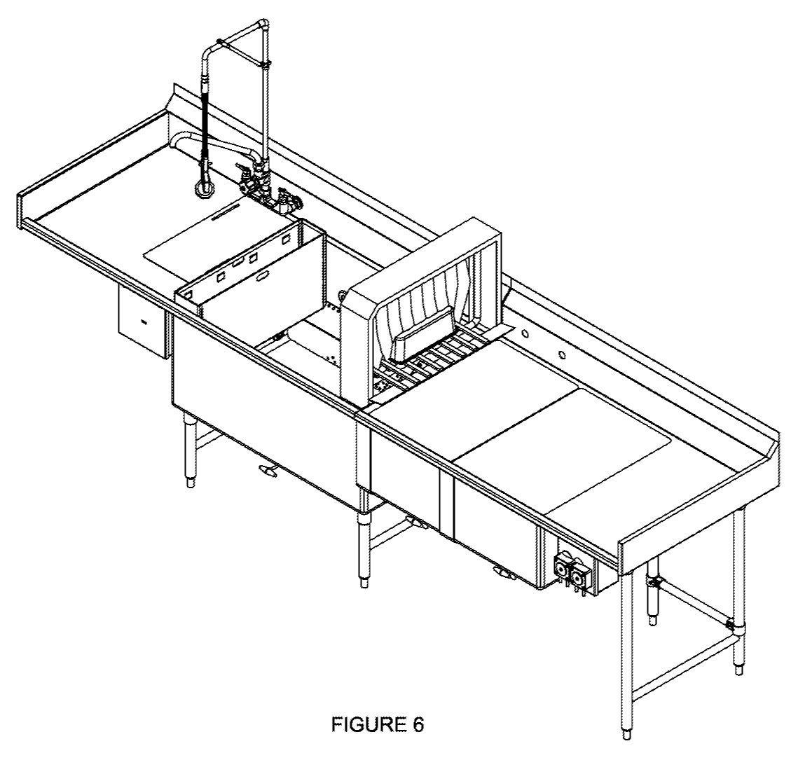

As is shown in FIGS. 5 and 6, a lid section 150 may be placed over the top of either or both of the rinse tank and sanitizer tank (or any tank, such as the scrap tank/sink), if such tanks are not desired to be utilized. This allows for additional work surface space within the footprint of the machine, while maintaining the rinse and/or sanitizing tanks within the machine as a backup in the event the rinse/sanitizer “window”™ is inoperable. In the embodiment shown in FIGS. 5 and 6, lid section 150 is a generally solid surface. Nevertheless, it will be appreciated that in alternative embodiments lid section 150 is a drain board, is made up of multiple rods, slats, tracks, mesh/perforated material, or any other suitable arrangement that, prevent items of a certain predetermined size from falling through into the tanks/sink over which lid 150 is located.

In one embodiment, such as is shown in FIGS. 5 and 6, the rinse/sanitizer “window”™ 10 is utilized for rinsing wares, and the rinse tank 130 is utilized as a sanitizer tank, with the sanitizer tank 140 being covered by a lid 150 and used as a work surface. In another embodiment, the rinse/sanitizer “window”™ is utilized for rinsing and sanitizing, and both the rinse tank 130 and sanitizer tank 140 are covered and used as work surfaces. It will be appreciated that either of the rinse tank 130 or the sanitizer tank 140 may be utilized for either rinsing or sanitizing without departing from the spirit and scope of the instant invention. In addition, a single tank may be utilized as both a rinse and sanitizer tank, or as a backup rinse/sanitizer tank, as opposed to the two separate tanks shown in FIGS. 2-6. Furthermore, it will be appreciated that alternative arrangements may be utilized in which the rinse/sanitizer window is located between the rinse and sanitizer tanks, or on the side of the sanitizer tank opposing the rinse tank without departing from the spirit and scope of the instant invention. Such arrangements would be particularly useful for a system in which a traditional rinse tank is used for rinsing and the rinse/sanitizer “window”™ 10 of the instant invention is utilized for sanitizing. Nevertheless, it will be appreciated that the rinse/sanitizer “window”™ 10 of the instant invention may be utilized for either rinsing or sanitizing regardless of its location.

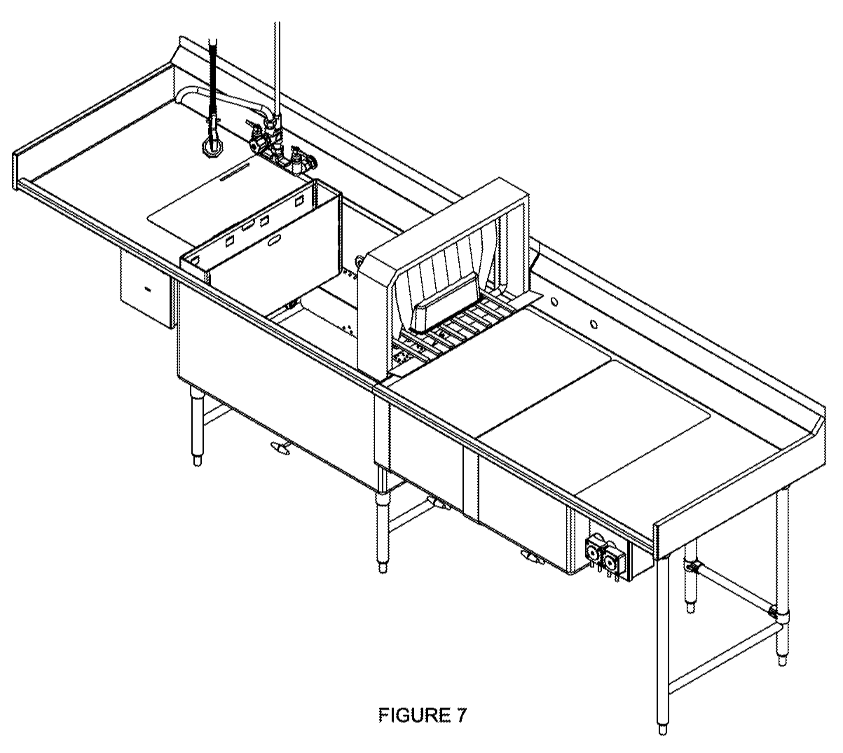

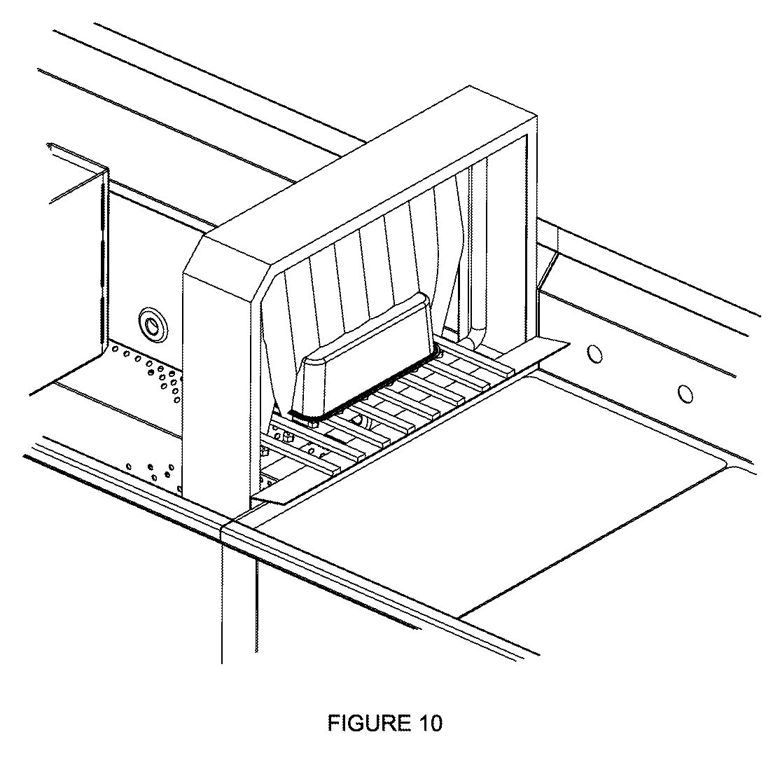

Referring to FIGS. 7-10 an embodiment of another pot and pan washing machine 200 is shown that includes the rinse/sanitizer “window”™ of FIG. 1. The pot and pan washing machine shown in FIGS. 7-10 includes, from left to right, a scrap tank 210, a wash tank 220, and a countertop work surface 250. The rinse/sanitizer “window”™ is mounted between the wash tank 220 and the countertop work surface 250. The support member 35 of the platform of the rinse/sanitizer “window”™ 10 is attached to the side of the wash tank 220 such that the elongated segments 30 of the platform extend over a portion of the wash tank 220. As is shown in FIG. 10, the support member includes a solid portion 37 that is located over the top of the countertop to add stability to the cantilevered arrangement. The open arrangement of the elongated segments allows fluid to drain from the rinse “window”™ into the wash tank.

In alternative embodiments to those shown if FIGS. 2-10, a separate drain-board may be located below the platform rinse/sanitizer “window”™ 10 of the instant invention such that the fluid from the rinse “window”™ does not drain into to wash tank. The drain board may be located above a portion of the wash tank, above a portion of the rinse or sanitizer tank, or between two of the tanks as an independent section of the washing machine. In addition, although described above as draining into the wash tank, it will be appreciated that the rinse “window”™ of the instant invention may drain into any of the of the tanks of the washing machine, or may drain independently from all of the tanks through the use of the drain-board.

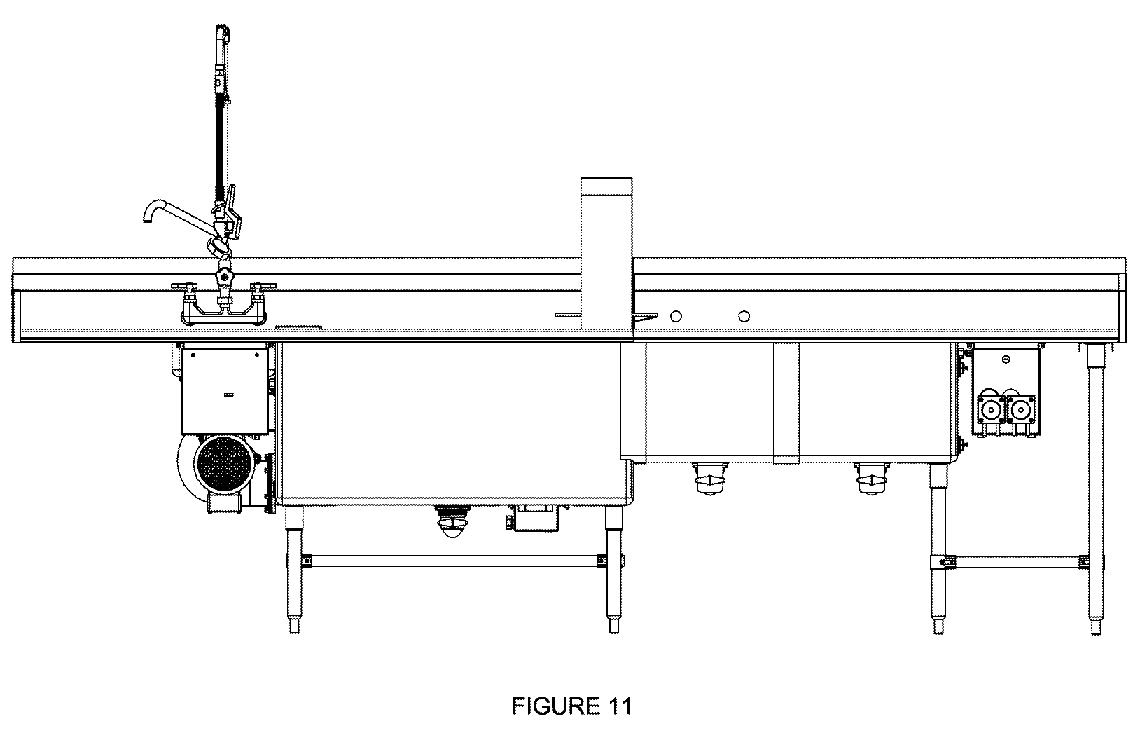

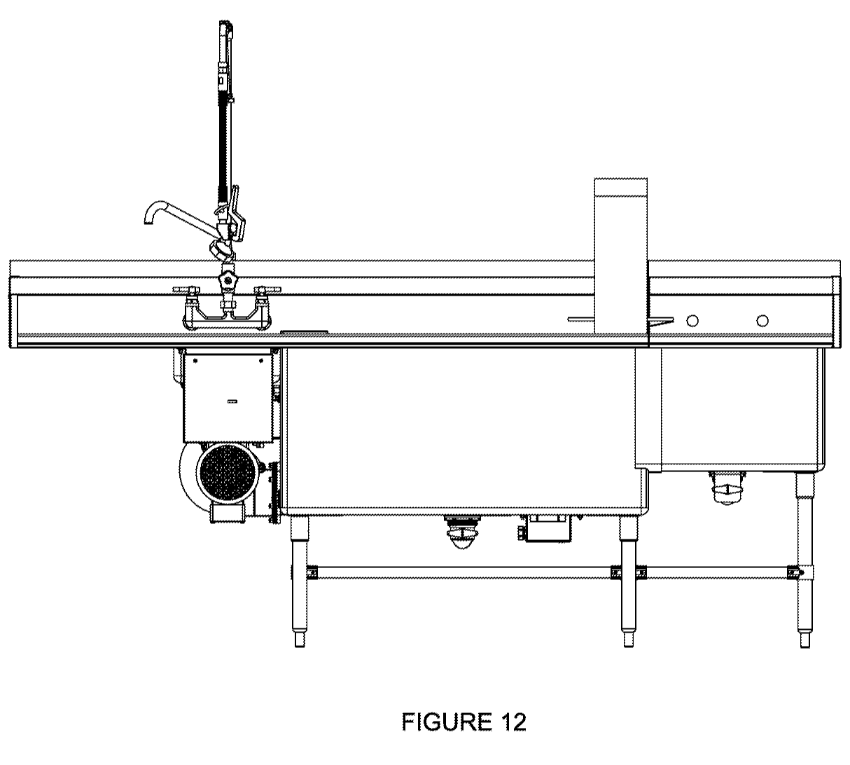

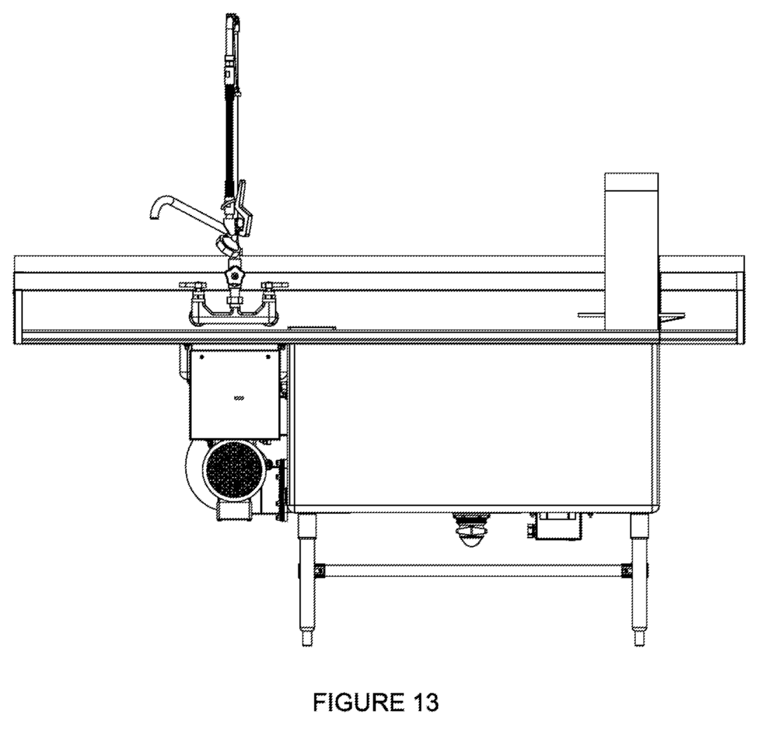

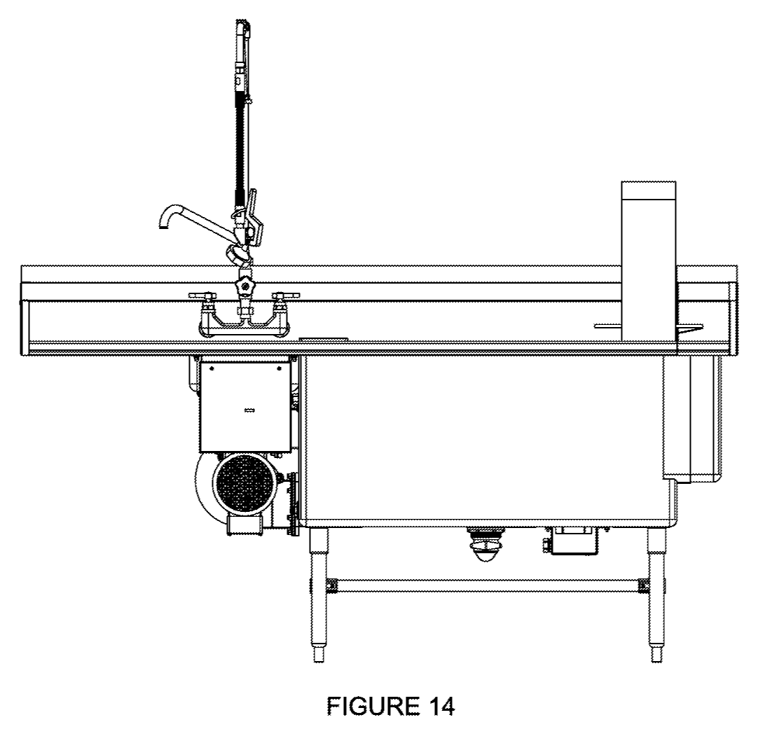

Referring to FIGS. 11 through 14, front views of several pot and pan washing machine embodiments that utilize the rinsing/sanitizing system 10 of FIG. 1 are shown to illustrate the ability to reduce the footprint of a washing machine with the rinsing/sanitizing system of the instant invention. FIG. 11 shows a front view of washing machine 300 including a scrap sink 310, wash sink 320, rinse sink 330 and sanitizer sink 340, as is traditionally found in washing machines of the prior art. Rinsing/sanitizing “window”™ 10 is attached to the side of wash tank 320 such that fluid dispensed from the system generally collects in the wash tank 320. FIG. 12 shows washing machine 300 with the sanitizer sink 340 removed, reducing the footprint of machine 300. In such machine, rinse/sanitizer “window”™ 10 is used for rinsing and/or for sanitizing wares. FIG. 13 shows washing machine 300 with both the sanitizer sink 340 and rinse sink 330 removed. It such system, rinse/sanitizer “window”™ 10 is used for both rinsing and for sanitizing wares. FIG. 14 shows washing machine 300 with sanitizer sink 340 removed and with the size of rinse sink 330 reduced significantly. It such system, rinse/sanitizer “window”™ 10 is used for both rinsing and for sanitizing wares. The rinse sink 330 in the embodiment shown in FIG. 14 is particularly well suited for a system in which rinsing and/or sanitizing fluid is recirculated through rinse/sanitizer “window”™ 10. In a preferred embodiment of the system shown in FIGS. 14, 80 to 100 gallons per minute of fluid are dispensed through nozzles 18 of rinse/sanitizer “window”™ 10 by pumping fluid out of tank 330. At the same time, only approximately 1.6 or less gallons per minute of clean fluid is consumed (or required to be “refreshed” into tank 330) due to fluid draining into wash tank 320 or otherwise splashing out of the system. In some embodiments, higher amounts of fluid may be consumed, such as 1.8 to 2.2 gallons per minute, depending upon desired fluid consumption rates. The rate of consumption may be controlled by controlling the location and shielding design of the rinse/sanitizer “window”™ 10. For example, to minimize consumption, rinse/sanitizer “window”™ 10 is positioned over rinse tank 330 in the embodiment shown in FIG. 14, rather than being positioned over wash tank 320 as is shown in FIGS. 11-13. The embodiments shown and described in FIG. 14 are particularly useful for minimizing fluid consumption while at the same time allowing the rinse and/or sanitizer fluid to be refreshed (to eliminate or minimize the need to drain and refill tank 330) and also providing sufficient fluid flow to create a full curtain of fluid that essentially allows all surfaces of an item passing through the curtain to be fully submerged within the fluid in a relatively short period of time. The high flowing curtain of fluid adequately removes soap on the items from the wash tank in one quick pass through the curtain, rather than requires a slow, conveyored or timed pass through or multiple passes through the system.

Another aspect of the invention is a method of rinsing an object by moving the object through the curtain of fluid of the rinse/sanitizer “window”™ described above. As shown in FIGS. 5-10, a pan is cleaned by moving the pan through the rinse/sanitizer “window”™. The rinse/sanitizer “window”™ described above is shown with fluid being discharged through nozzles toward opposing conduits to form a curtain of fluid in a generally common plane. The pan is washed within wash tank 120 and removed from the wash tank 120 and placed on elongated members 30 to slide along the platform, through the curtain of fluid that is created by the rinse/sanitizer “window”™ 10. The splash shield prevents the fluid from escaping the confines of the rinse/sanitizer “window”™. As the pan passes through the rinse/sanitizing “window”™, it is sprayed by the fluid from opposite directions, thereby rinsing the pan, or other object. In one embodiment, the fluid is water, and the rinse “window”™ is used to rinse soapy water from a wash tank off the object. In another embodiment, the fluid is a sanitizer agent. In still another embodiment, both a fluid and sanitizer agent is sprayed from the rinse “window”™ (either as a mixture or through separate spray cycles).

As shown in FIGS. 5 and 6, the pan moves away from a wash basin, through the rinse/sanitizer “window”™, into a rinse basin. In this embodiment, gravity causes the pan to drop into the rinse basin 130. In a preferred embodiment in which the rinse/sanitizer “window”™ 10 is used to rinse an item with water or other rinse fluid, the rinse sink 130 is filled with a sanitizer agent. In this manner, the item is sanitized when it drops into the wash tank. A system operator then removes the item from the rinse sink 130 (in which sanitizer agent is located). As shown in FIGS. 7-10, the pan moves away from the wash basin, through the rinse/sanitizer “window”™, directly on to a flat surface or drying station.

The system and method of the instant invention provides an operator of the system the ability to complete all tasks from a single stationary position. In particular, in the embodiment shown in FIGS. 7-10, washing, rinsing and sanitizing can all be accomplished from a single stationary position immediately in front of wash sink 220. An operator simple removes items from wash tank 220, and manually (in the shown embodiment) pushes those items through rinse/sanitizer “window”™ 10 located adjacent to and at a height above the wash tank 220. As items are pushed through rinse/sanitizer “window”™ 10, they are pushed down onto and along work surface 250. This increases speed, is more efficient and increases hourly throughput by the operator.

Referring to FIG. 13, wash pump 370 is shown mounted on the left side of wash tank 320 to draw wash fluid from within wash tank 320 and redispense such fluid through openings in the wash tank to create a continuous wash action within wash tank 320. In prior art systems in which separate wash, rinse and sanitizer tanks are required, the pump 370 is typically located to the side of the wash tank 320 opposite the rinse tank. This is because the rinse tank prevented or blocked the ability to have an intake port through the side wall adjacent the rinse tank. The instant invention allows the pump 370 to be positioned on either end of the wash tank, further allowing the footprint of machine 300 to be further reduced or manipulated as desired.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and/or claimed herein. Consequently, the scope of the present invention is intended to be limited only by any attached claims, all matter contained in the above description and shown in the accompanying drawings shall be interpreted as illustrative and not in a limiting sense.

It is also to be understood that any claims are intended to cover all of the generic and specific features of the invention herein described, and all statements of the scope of the invention which, as a matter of language, might be said to fall therebetween.

What is claimed is:

1. A rinsing and/or sanitizing system for a washing system that traditionally includes wash and rinse sinks, or wash, rinse and sanitize sinks, the system comprising:
one or more sections of conduit with at least one fluid-dispensing opening along a portion of length of said one or more sections of conduit;
wherein said at least one opening is sized, shaped and located such that fluid dispensed through said at least one opening generally creates one or more curtains of fluid; and
wherein said conduit is located generally adjacent to a first wash sink.

2. The system as claimed in claim 1 wherein the rinse and/or sanitize system allows for reduction of, reallocation of, replacement of and/or elimination entirely of a middle rinse sink and/or a third sanitizer sink.

3. The system as claimed in claim 1 wherein said conduit is located at least partially over the first sink.

4. The system as claimed in claim 1 wherein said conduit is located at least partially over a second sink that is generally adjacent to the first sink.

5. The system as claimed in claim 1 wherein said conduit is located at least partially over a drain board that is generally adjacent to the first sink.

6. The system as claimed in claim 1 further comprising a control for initiating and stopping the flow of fluid through the conduit and out the at least one opening.

7. The system as claimed in claim 6, wherein the control is a manually operated foot pedal.

8. The system as claimed in claim 6, wherein the control is an optical sensor.

9. The system as claimed in claim 6, wherein the control is a pressure sensitive start button.

10. The system as claimed in claim 1, wherein the fluid includes a sanitizing agent.

11. The system as claimed in claim 1 further including a sanitizing agent introduced adjacent to said one or more curtains of fluid.

12. The system as claimed in claim 1, wherein said conduit and said at least one opening are arranged such that the one or more curtains of fluid created is vertical.

13. The system as claimed in claim 1, further comprising a splash shield forming a perimeter around the one or more curtains of fluid such that most of the fluid of the one or more curtains of fluid is contained within the perimeter of the splash shield while the fluid is airborne.

14. The system as claimed in claim 1, further comprising a platform, wherein the platform is comprised of a plurality of elongated bodies arranged substantially parallel to each other and each elongated body is arranged substantially perpendicular to the one or more curtains of fluid; wherein each of the elongated bodies extends in opposite directions through the one or more curtains of fluid.

15. The system as claimed in claim 1 wherein said at least one opening includes at least one first opening that dispenses fluid in a first direction, and at least one second opening that dispenses fluid in a second direction generally opposing said first direction and generally toward said at least one first opening.

16. The system as claimed in claim 15 wherein said at least one first opening dispenses fluid generally downward from an upper portion of said conduit and wherein said at least one second opening dispenses fluid generally upward from a lower portion of said conduit.

17. The system as claimed in claim 1 wherein said one or more sections of conduit forms a generally c or u shaped channel.

18. The system as claimed in claim 2 further comprising a lid or drain board located over the rinse and/or sanitizer sinks.

19. The system as claimed in claim 2 wherein at least a portion of the rinse and/or sanitize system is cantilevered over the wash, rinse and/or sanitizer sinks.

20. A method of rinsing items washed in a wash sink comprising the steps of:
washing items within a first sink basin;
removing said items from said first sink basin;
creating a curtain of fluid associated with and at a height generally higher than said first sink basin; and
moving said items through said curtain of fluid, away from said first sink basin and into a work space generally adjacent to said first sink basin.

21. The method as claimed in claim 20 wherein said curtain of fluid comprises water.

22. The method as claimed in claim 20 wherein said curtain of fluid comprises a sanitizing agent.

23. The method as claimed in claim 20 wherein said curtain of fluid is located at least partially over said first sink basin.

24. The method as claimed in claim 20 wherein said curtain of fluid is located at least partially over a second sink basin adjacent to said first sink basin, and wherein in said moving step said items fall into said second sink basin.

25. The method as claimed in claim 20 wherein in said moving step said items move to a work surface including a height generally lower than the height of the curtain of fluid.

26. The method as claimed in claim 20 wherein in said moving step said items are moved along tracks that extend through said curtain of fluid.

27. The method as claimed in claim 20 wherein said curtain of fluid is generally vertical.

28. The method as claimed in claim 20 wherein in said moving step said items are manually pushed through said curtain of fluid.

29. The method as claimed in claim 28 wherein washing, rinsing and sanitizing of items is completed from a stationary position immediately in front of the wash sink.
